(19) United States
(12) Patent Application Publication
(10) Pub. No.: US 2012/0221334 A1
(43) Pub. Date: Aug. 30, 2012

(54) SECURITY SYSTEM AND METHOD

(75) Inventor: HONG-RU ZHU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/195,850

(22) Filed: Aug. 2, 2011

(30) Foreign Application Priority Data
Feb. 25, 2011 (CN) 201110045739.0

(51) Int. Cl. G10L 17/00

(52) U.S. Cl. 704/246; 704/E15.001

(57) ABSTRACT

A security system and method includes setting operation steps having a preset sequence, a trigger signal and a testing parameter for each of the operation steps, and a range of each of the testing parameters. The method further confirms a current operation step when a testing device starts a test process. If an output signal received from a sensing device is not identical to the trigger signal of the current operation step, a voice content file of the current operation step is sent to the voice output device. If a value of the output parameter read from the sensing device is not within the range of the testing parameter, a voice prompt file of the testing parameter is sent to the voice output device. After sending the voice content file or the voice prompt file, an abnormality processing command of the current operation step is sent to the testing device to stop the test process.

### BACKGROUND

1. Technical Field

Embodiments of the present disclosure relate to a security technology, and more particularly to a security system and method implemented by a computing device.

2. Description of Related Art

Many operations in a test process may be related to personal security. Accidents may be caused easily if misoperations or incorrect operation steps have been generated. For example, the misoperations may bring about a voltage, a current or a temperature, and other abnormal situations. The abnormal situations may threaten devices under test, testing devices, and testing operators. Therefore, security in the test process is very important.

### BRIEF DESCRIPTION OF THE DRAWINGS

FIG. 1 is a schematic diagram of one embodiment of a computing device including a security system.

FIG. 2 is a block diagram of one embodiment of the security system of FIG. 1.

FIG. 3 is a flowchart of one embodiment of a security method implemented by a computing device, such as, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

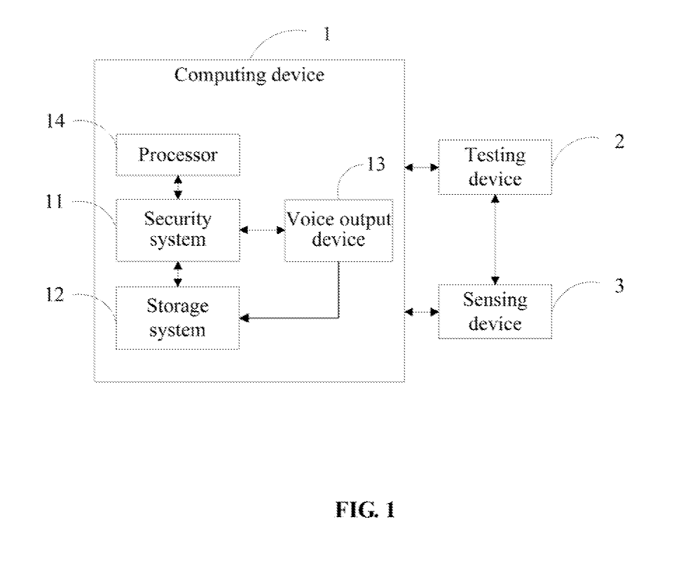

FIG. 1 is a block diagram of one embodiment of a computing device 1. The computing device 1 includes a security system 11 and a voice output device 13. The computing device 1 communicates with a testing device 2 and a sensing device 3, to control the testing device 2 and read sensed data from the sensing device 3. The testing device 2 may include a plurality of devices and components, such as a circuit board, a test fixture and a device power supply, to perform a test process of the testing device 2. The test process tests hardware. The sensing device 3 may include a plurality of sensors, such as temperature sensors, voltage sensors, current sensors and other sensors, for testing corresponding parameters (e.g. temperatures, voltages, and currents). The sensing device 3 communicates with the testing device 2, and monitors output data generated by the testing device 2. The output data may include, but are not limited to, a temperature, a voltage, and a current output from the testing device 2.

The security system 11 may monitor the testing parameters and the test process of the testing device 2 through the sensing device 3, and prompt users with voice information when there are abnormities in the test process. The voice output device 13 can play one or more audio files to output the voice information. The audio files may include a voice content file for each of the operation steps that comprises an audio file detailing operation content of the operation step, and a voice prompt file for each of the testing parameters that comprises a voice prompt message of each of the testing parameters.

The computing device 1 further includes a storage system 12 and at least one processor 14. The storage system 12 may store various data of the computing device 1, such as the various voice files, for example. The at least one processor 14 executes one or more computerized codes and other applications of the computing device 1, to provide functionality for the computing device 1.

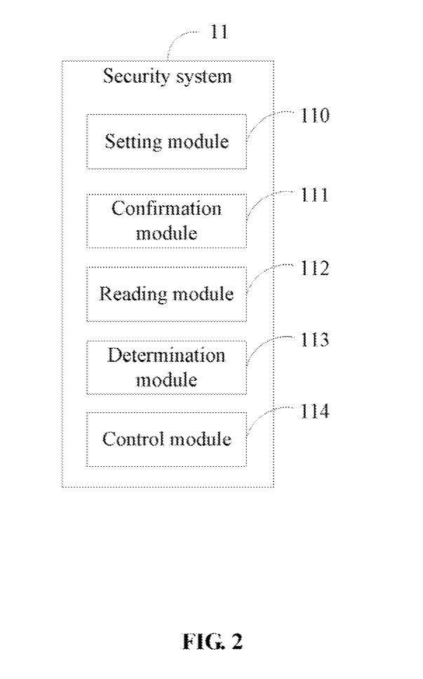

FIG. 2 is a block diagram of one embodiment of the security system 11 included in the computing device 1 of FIG. 1. In some embodiments, the security system 11 may include a setting module 110, a confirmation module 111, a reading module 112, a determination module 113, and a control module 114. The modules 110-114 comprise computerized codes in the form of one or more programs that are stored in the storage system 12. The computerized code includes instructions that are executed by at least one processor 14 to provide functions for the modules. Details of these operations are as follows.

The setting module 110 sets an operation sequence table and a recovery command according to the test process of the testing device 2, and stores the operation sequence table and the recovery command in the storage system 12. In the embodiment, the operation sequence table is a table that includes operation steps of the testing device 2 that are required to be monitored having a preset sequence, a trigger signal and a testing parameter for each of the operation steps, and a range of each of the testing parameters. The operation steps are set in the preset sequence, such as, “step 1”, and “step 2”, for example. The trigger signal for each of the operation steps may be generated by an output signal sensed from the sensing device 3 when the test device 2 executes each of the operation steps. The testing parameter may be, but are not limited to, a temperature signal, a voltage signal, and a current signal. In some embodiments, the recovery command may be a command for restarting the testing device 2. The trigger signal for each of the operation steps and the testing parameter for each of the operation steps may be set according to actual requirements.

The setting module 200 further sets a voice content file and an abnormality processing command for each of the operation steps, and stores the voice content files and the abnormality processing command for each of the operation steps in the storage system 12. The setting module 200 further sets a voice prompt file for each of the testing parameters, and stores the voice prompt file for each of the testing parameters in the storage system 12. The voice content file for each of the operation steps comprises voice of detailed operation content for each of the operation steps, and the voice prompt file for each of the testing parameters comprises voice of a prompt message for each of the testing parameters. The abnormality processing command may be a command to control the testing device 2, such as a command to disable the testing device 2, upon the condition that each of the operation steps or each of the testing parameters is abnormal.

The confirmation module 111 confirms a current operation step according to the preset sequence of the operation steps, upon the condition that the testing device 2 starts the test process.

The reading module 112 receives an output signal from the sensing device 3, and reads an output parameter sensed from the sensing device 3.

The determination module 113 determines whether the received output signal is identical to the trigger signal of the current operation step. For example, if the operation steps in the preset sequence include “step 1”, “step 2” and “step 3”, and the corresponding trigger signals are “signal 1”, “signal 2” and “signal 3”. When the test process is started, the confirmation module 111 confirms that the current operation step is “step 1”. If the reading module 112 has received the trigger signal “signal 1” corresponding to the “step 1”, the determination module 113 determines that the received output signal is identical to the trigger signal of the current operation step. If the current operation step is confirmed to be the “step 1”, and the reading module 112 has received the trigger signal “signal 2” (not corresponding to the “step 1”), the determination module 113 determines that the received output signal is not identical to the trigger signal of the current operation step.

Upon the condition that the received output signal is not identical to the trigger signal of the current operation step, the control module 114 reads the voice content file of the current operation step from the storage system 12, and sends the voice content file to the voice output device 13. When the voice content file is received, the voice output device 13 plays the voice content file to prompt a correct operation step.

Upon the condition that the received output signal is identical to the trigger signal of the current operation step, the determination module 113 further determines whether a value of the read output parameter is within the range of the testing parameter of the current operation step. In some embodiments, the determination module 113 determines whether the value of the read output parameter is lower than or equal to a maximum value of the range of the testing parameter, and greater than or equal to a minimum value of the range of the testing parameter.

Upon the condition that the value of the read output parameter is not within the range of the testing parameter, the control module 114 further reads the voice prompt file of the testing parameter from the from the storage system 12, and sends the voice prompt file to the voice output device 13 to play.

Upon the condition that the value of the read output parameter is within the range of the testing parameter, the determination module 113 further determines whether the test process has been finished. If the current operation step is a last operation of the operation steps in the preset sequence, the determination module 113 determines that the test process has been finished.

The control module 114 further sends the abnormality processing command corresponding to the current operation step to the testing device 2 to stop the test process, when the voice content file or voice prompt file is sent to the voice output device 13.

The determination module 113 further determines whether the recovery command has been received.

Upon the condition that the recovery command has been received, the control module 114 further controls the testing device to test normally.

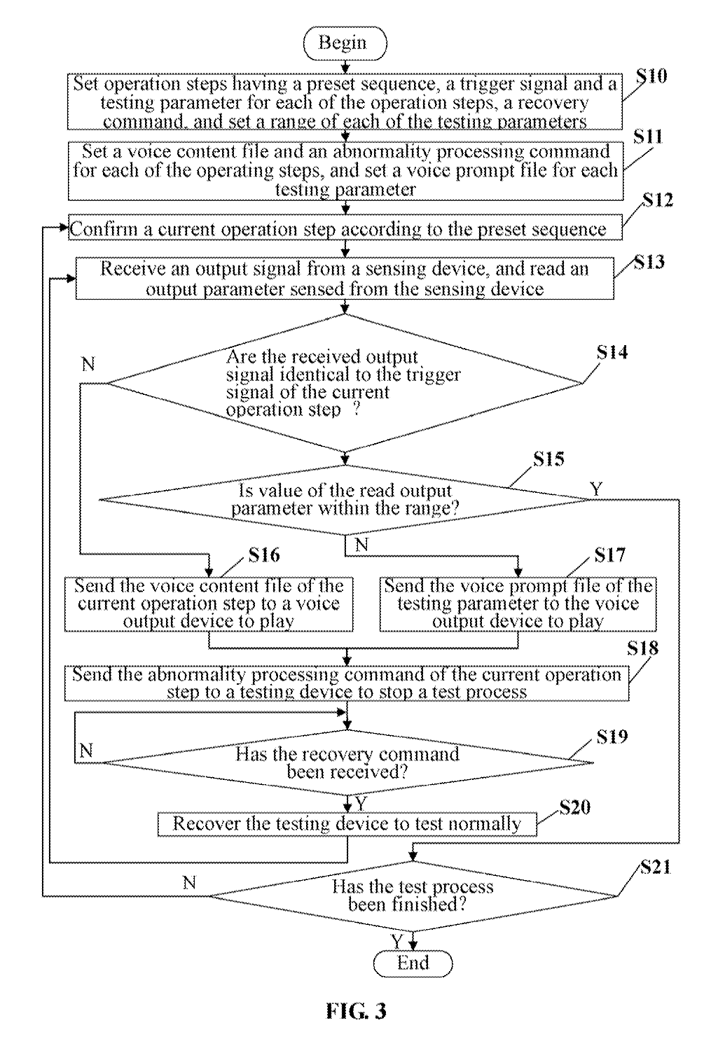

FIG. 3 is a flowchart of one embodiment of a security method of the computing device, such as, that of FIG. 1. Depending on the embodiment, additional blocks may be added, others deleted, and the ordering of the blocks may be changed.

In block S10, the setting module 110 sets an operation sequence table and a recovery command according to the test process of the testing device 2, and stores the operation sequence table and the recovery command into the storage system 12. The operation sequence table includes operation steps required to be monitored having a preset sequence, a trigger signal and the testing parameter for each of the operation steps, and a range of each of the testing parameters.

In block S11, the setting module 200 sets a voice content file and an abnormality processing command for each of the operation steps, and a voice prompt file for each of the testing parameters, and stores the voice content files and the abnormality processing command of each of the operation steps, the voice prompt file of each of the testing parameters in the storage system 12.

In block S12, the confirmation module 111 confirms a current operation step according to the preset sequence of the operation steps when the testing device 2 starts the test process.

In block S13, the reading module 112 receives an output signal from the sensing device 3, and reads an output parameter sensed from the sensing device 3.

In block S14, the determination module 113 determines whether the received output signal is identical to the trigger signal of the current operation step. If the received output signal is identical to the trigger signal of the current operation step, block S15 is implemented. Otherwise, if the received output signal is not identical to the trigger signal of the current operation step, block S16 is implemented.

In block S15, the determination module 113 determines whether a value of the read output parameter is not within the range of the testing parameter of the current operation step. If the value of the read output parameter is not within the range of the testing parameter, block S17 is implemented. Otherwise, if the value of the read output parameter is within the range of the testing parameter, block S21 is implemented.

In block S16, the control module 114 reads and sends the voice content file of the current operation step from the storage system 12, and sends the voice content file of the current operation step to the voice output device 13, and block S18 is implemented.

In block S17, the control module 114 reads the voice prompt file of the testing parameter from the storage system 12, and sends the voice prompt file of the testing parameter to the voice output device 13 to play.

In block S18, the control module 114 sends the abnormality processing command corresponding to the current operation step to the testing device 2 to stop the test process.

In block S19, the determination module 113 further determines the recovery command has been received. If the recovery command has been received, block S20 is implemented. Otherwise, if the recovery command has not been received, block S19 is repeated.

In block S20, the control module 114 controls the testing device to test normally, and block S13 is repeated.

In block S21, the determination module 113 determines whether the test process has been finished. If the current operation step is a last operation of the operation steps in the preset sequence, the determination module 113 determines that the test process has been finished. If the test process has not been finished, block S12 is repeated.

It should be emphasized that the described exemplary embodiments are merely possible examples of implementations, and have been set forth for a clear understanding of the principles of the present disclosure. Many variations and modifications may be made to the-described exemplary embodiments without departing substantially from the spirit and principles of the present disclosure. All such modifications and variations are intended to be included herein within the scope of this disclosure and the described inventive embodiments, and the present disclosure is protected by the following claims.

What is claimed is:

1. A computing device, comprising:
a voice output device;
at least one processor;
one or more programs that are stored in the storage system and are executed by the at least one processor, the one or more programs comprising:
a setting module operable to set operation steps having a preset sequence, a trigger signal and a testing parameter for each of the operation steps, and a range of each of the testing parameters, according to a test process of a testing device in communication with the computing device, set a voice content file and an abnormality processing command for each of the operation steps, and set a voice prompt file for each of the testing parameters;
a confirmation module operable to confirm a current operation step according to the preset sequence of the operation steps, upon the condition that the testing device starts the test process;
a reading module operable to receive an output signal from a sensing device in communication with the computing device, and read an output parameter sensed from the sensing device;
a control module operable to send the voice content file of the current operation step to the voice output device to play, upon the condition that the received output signal is not identical to the trigger signal of the current operation step;
the control module further operable to send the voice prompt file of the testing parameter to the voice output device to play, upon the condition that a value of the read output parameter is not within the range of the testing parameter of the current operation step;
the control module further operable to send the abnormality processing command corresponding to the current operation step to the testing device to stop the test process.

2. The computing device as claimed in claim 1, wherein the setting module is further operable to set a recovery command, and the control module is further operable to recover the testing device to test normally upon the condition that the computing device has received the recovery command.

3. The computing device as claimed in claim 1, wherein the one or more programs further comprise:
a determination module operable to determine whether the test process has been finished, upon the condition that the value of the read output parameter is within the range of the testing parameter.

4. The computing device as claimed in claim 3, wherein the determination module determines the test process has been finished, upon the condition that the current operation step is a last operation of the operation steps in the preset sequence.

5. The computing device as claimed in claim 1, wherein the voice content file for each of the operation steps comprises voice of a detailed operation content of each of the operation steps, and the voice prompt file for each of the testing parameters comprises a voice prompt message of each of the testing parameters.

6. The computing device as claimed in claim 1, wherein the sensing device comprises a plurality of sensors for sensing output data of the testing device.

7. A security method implemented by a computing device, the computing device comprising a voice output device, the method comprising:
setting operation steps having a preset sequence, a trigger signal and a testing parameter for each of the operation steps, and a range of each of the testing parameters, according to a test process of a testing device in communication with the computing device;
setting a voice content file and an abnormality processing command for each of the operation steps, and setting a voice prompt file for each of the testing parameters;
confirming a current operation step according to the preset sequence of the operation steps, upon the condition that the testing device starts the test process;
receiving an output signal from a sensing device in communication with the computing device, and reading an output parameter sensed from the sensing device;
sending the voice content file of the current operation step to the voice output device to play, upon the condition that the received output signal is not identical to the trigger signal of the current operation step; or
sending the voice prompt file of the testing parameter to the voice output device to play, upon the condition that a value of the read output parameter is not within the range of the testing parameter of the current operation step;
sending the abnormality processing command corresponding to the current operation step to the testing device to stop the test process.

8. The method as claimed in claim 7, further comprising:
setting a recovery command; and
recovering the testing device to test normally, upon the condition that the recovery command has been received.

9. The method as claimed in claim 7, further comprising:
determining whether the test process has been finished, upon the condition that the value of the testing parameter is within the range of the testing parameter.

10. The method as claimed in claim 9, further comprising:
finishing the test process, upon the condition that the current operation step is a last operation of the operation steps in the preset sequence.

11. The method as claimed in claim 7, wherein the voice content file for each of the operation steps comprises a detailed operation content of each of the operation steps, and the voice prompt file for each of the testing parameters comprises a voice prompt message of each of the testing parameters.

12. The method as claimed in claim 7, wherein the sensing device comprises a plurality of sensors for sensing output data of the testing device.

13. A non-transitory storage medium storing a set of instructions, the set of instructions capable of executed by a processor to perform a security method using a computing device, the computing device comprising a voice output device, the method comprising:
setting operation steps having a preset sequence, a trigger signal and a testing parameter for each of the operation steps, and a range of each of the testing parameters, according to a test process of a testing device in communication with the computing device;
setting a voice content file and an abnormality processing command for each of the operation steps, and setting a voice prompt file for each of the testing parameters;
confirming a current operation step, according to the preset sequence of the operation steps, upon the condition that the testing device starts the test process;
receiving an output signal from a sensing device in communication with the computing device, and reading an output parameter sensed from the sensing device;
sending the voice content file of the current operation step to the voice output device to play, upon the condition that the received output signal is not identical to the trigger signal of the current operation step; or
sending the voice prompt file of the testing parameter to the voice output device to play, upon the condition that a value of the read output parameter is not within the range of the testing parameter of the current operation step;
sending the abnormality processing command corresponding to the current operation step to the testing device to stop the test process.

14. The storage medium as claimed in claim 13, further comprising:
setting a recovery command; and recovering the testing device to test normally, upon the condition that the recovery command has been received.

15. The storage medium as claimed in claim 13, further comprising:
determining whether the test process has been finished, upon the condition that the value of the read output parameter is within the range of the testing parameter.

16. The storage medium as claimed in claim 15, further comprising:
finishing the test process, upon the condition that the current operation step is a last operation of the operation steps in the preset sequence.

17. The storage medium as claimed in claim 13, wherein the voice content file for each of the operation steps comprises a detailed operation content of each of the operation steps, and the voice prompt file for each of the testing parameters comprises a voice prompt message of each of the testing parameters.

18. The storage medium as claimed in claim 13, wherein the sensing device comprises a plurality of sensors for sensing output data of the testing device.
